(19) United States
(12) Patent Application Publication
(10) Pub. No.: US 2004/0133648 A1
(43) Pub. Date: Jul. 8, 2004

(54) Data terminal method and apparatus capable of storing information using URL

(76) Inventor: Hiroshi Tamura, Kanagawa-ken (JP)

Correspondence Address: Cooper & Dunham LLP, 1185 Avenue of the Americas, New York, NY, 10036, US

(21) Appl. No.: 10/653,880

(22) Filed: Sep. 2, 2003

(30) Foreign Application Priority Data
Sep. 2, 2002 (JP) 2002-256418

(51) Int. Cl. G06F 15/16; H04N 1/00

(52) U.S. Cl. 709/207; 709/206; 358/403

(57) ABSTRACT

A network terminal apparatus connected to a local area network and a public switched telephone network, includes an information receiving mechanism to receive one of facsimile information and email, a memory storing a plurality of addresses assigned in a file server connected to the local area network and a plurality of protocols corresponding to the plurality of addresses, an information transmitting mechanism to transmit one of facsimile information and email received by the information receiving mechanism to a universal resource locator including information of one of the plurality of addresses and corresponding one of the plurality of protocols when a specific event occurs and an email generator to generate an email indicating the universal resource locator to a specific email address.

### BACKGROUND

1. Field

The present patent specification relates to a network terminal apparatus for transporting image information through a network, i.e., a local area network or a public switched telephone network, and more particularly to a network terminal apparatus capable of forwarding a document to a file server using URL and sending an email indicating the Universal Resource Locator (URL) from which the document is retrieved.

2. Discussion

With an Internet globally disseminated and developed in recent years, communications using global communications lines such as the Internet, for example, have been widely accepted as well as communications via the public switched telephone network (PSTN) and the integrated services digital network (ISDN).

The above-described trend demonstrates that with the full usage of the cost-effective Internet, users desire to reduce costs for communications, thereby increasing the number of network terminals that are attached to the network. There is an increasing number of terminals that can be attached to the Internet and the terminals include network terminal devices including facsimiles, for example, which transmit and receive image data. A variety of standard facsimiles function as network facsimiles conforming to standards such as the standard T.37, a new ITU-T standard for transferring of facsimile messages via store and forward over packet-switched IP network and the T.38, a new ITU-T standard for sending real-time facsimile messages, for example, which are established by the International Telecommunications Union-Telecommunications Services Sector (ITU-T)

Unexamined Japanese Laid-Open Patent Application Publication No. 2002-027194 discusses a technology in which when an Internet facsimile receives two or more documents with attached data files that the Internet facsimile is unable to handle, the data files are correctly printed out.

In another example of conventional technology, unexamined Japanese Laid-Open Patent Application Publication No. 2001-339549 discusses that when a user desires to send a document using devices such as a facsimile or a personal computer and determines that a receiver such as a facsimile or a personal computer, for example, is unable to receive the document, the sender arranges a document to be forwarded to another destination.

Given that an Internet mail is now widely used, it is clear that the network facsimiles which are connected on the network, given an email address and provided with a function to exchange mails will receive an electric mail with various contents from an indefinite number of counterparts.

Unfortunately, however, the conventional network facsimiles cannot always properly process all the received messages and the document may sometimes get misplaced and lost. For example, when a network facsimile receives a document file compiled by an application software on a personal computer, the network facsimile does not necessarily decode and print the document file and resources can be wasted. In one example, the tray is low on paper, toner is overspent or there is a memory overrun, thereby preventing the storing and/or printing of a document.

### SUMMARY

In view of the foregoing, it is an object to provide a novel network terminal apparatus capable of forwarding a document to a file server using URL and sending an email indicating the Universal Resource Locator (URL) from which the document is retrieved.

It is another object to provide a novel network terminal method capable of forwarding a document to a file server using URL and sending an email indicating the Universal Resource Locator (URL) from which the document is retrieved.

To achieve the above-mentioned objects and others, a novel network terminal apparatus connected to a local area network and a public switched telephone network includes an information receiving mechanism to receive one of facsimile information and email, a memory storing a plurality of addresses assigned in a file server connected to the local area network and a plurality of protocols corresponding to the plurality of addresses, an information transmitting mechanism to transmit said one of facsimile information and email received by the information receiving mechanism to a universal resource locator including information of one of the plurality of addresses and corresponding one of the plurality of protocols when a specific event occurs and an email generator to generate an email indicating the universal resource locator to a specific email address.

In the novel network terminal apparatus, the specific event can be that a part or an entire portion of one of facsimile information and email received is not decodable.

In the novel network terminal apparatus, the specific event can be that a document of one of facsimile information and email received is not printed out or saved.

In the novel network terminal apparatus, the specific event can be that a part or an entire portion of one of facsimile information and email received is not printed out or saved.

In the novel network terminal, the forward URL is included in contents of a predetermined communication control report which stores a communication history.

To achieve these and other objects, a novel network terminal apparatus connected to a local area network and a public switched telephone network carries out steps including receiving one of facsimile information and email, storing a plurality of addresses assigned in a file server connected to the local area network and a plurality of protocols corresponding to the plurality of addresses, transmitting one of facsimile information and email received by the information receiving mechanism to a universal resource locator including information of one of the plurality of addresses and corresponding one of the plurality of protocols when a specific event occurs and generating an email indicating the universal resource locator to a specific email address.

In the network terminal method, the specific event can be that a part or an entire portion of one of facsimile information and email received is not decodable.

In the network terminal method, the specific event can be that a document of one of facsimile information and email received is not printed out or saved.

In the network terminal method, the specific event can be that a part or an entire portion of one of facsimile information and email received is not printed out or saved.

In the network terminal method, the forward URL is included in contents of a predetermined communication control report which stores a communication history.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram showing an exemplary structure of a local network system according to a preferred embodiment;

FIG. 2 is a block diagram showing an exemplary structure of a network facsimile FX;

FIG. 3 is a flowchart showing an exemplary procedure of the network facsimile FX after the network facsimile FX receives facsimile information or an email;

FIG. 4 shows a data table 3a of the parameter table 3;

FIG. 5A is a diagram showing an exemplary illustration of a notification mail;

FIG. 5B is a diagram showing an exemplary illustration of a notification mail;

FIG. 5C is a diagram showing an exemplary illustration of a notification mail;

FIG. 5D is a diagram showing an exemplary illustration of a notification mail;

FIG. 6 is a diagram showing an exemplary illustration of a communication administration report.

### DETAILED DESCRIPTION OF PREFERRED EMBODIMENTS

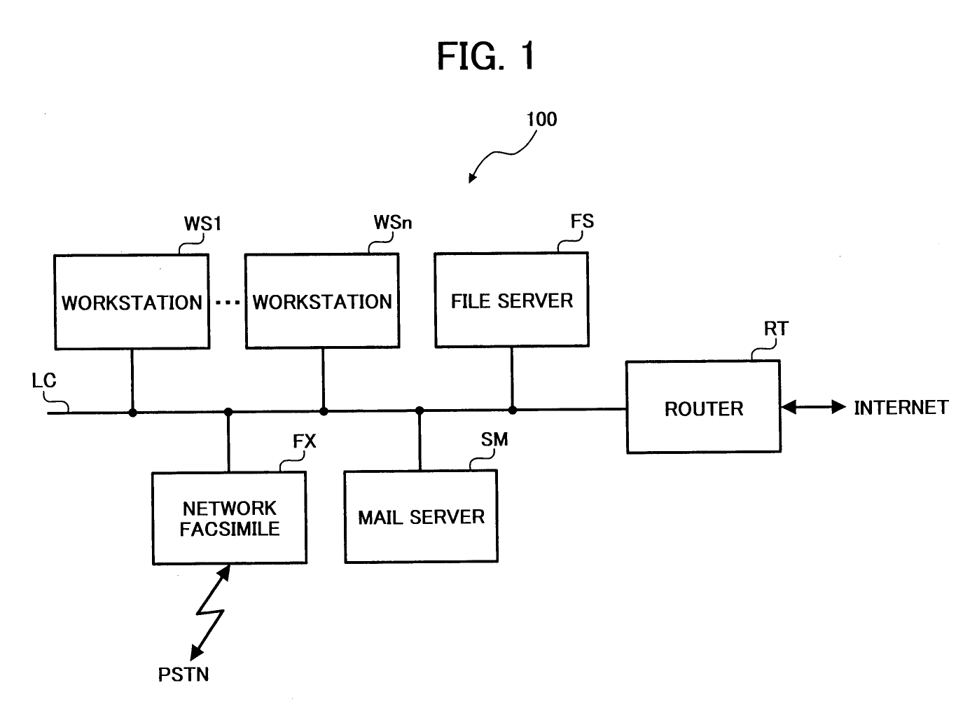

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, a description is made for a LAN (local area network) system 100 according to a preferred embodiment. As shown in FIG. 1, the LAN system 100 includes workstations WS1 through WSn, a mail server SM, a file server FS, a network facsimile FX, a router RT and a LAN cable LC. The LAN system 100 communicatively connects through the LAN cable LC the workstations WS1 through WSn, the mail server SM, the file server FS, and the network facsimile FX. The LAN system 100 is connected to the Internet via the router RT. The workstations WS1 through WSn, the mail server SM, the file server FS, the network facsimile FX and the router RT exchange data with other terminals via the LAN system 100 or the Internet.

The mail server SM collects and distributes a notification mail to each of the users of the workstations WS1 through WSn and the network facsimile FX.

The file server FS receives and saves a file from the workstations WS1 through WSn or from the network facsimile FX using predetermined file transfer protocols such as the Hypertext Transfer Protocol (HTTP) or the File Transfer Protocol (FTP), for example. The files stored in the file server FS are sent to workstations WS1 through WSn or to the network facsimile FX using the predetermined file transfer protocol.

The workstations WS1 through WSn include various programs for running a network facsimile application software which creates and displays facsimile information and also programs for various kinds of software for exchanging data via the LAN system 100. The privilege to use the above-described programs is given only a specific user or specific users. The specific users explained herein may be a plurality of users.

One of the workstations WS1 through WSn is configured to be used by a specific user, that is, a network administrator and when an abnormal event occurs at the time of receiving a document, the network facsimile FX creates a notification mail containing information about the abnormal event and sends the notification mail notifying that an abnormal event has occurred to the network administrator.

The network facsimile FX is provided with an email process function which exchanges image information or a transmission function to transmit image information via the analog PSTN and using the LAN system 100 to a public line in compliance with a G3 FAX transmission procedure.

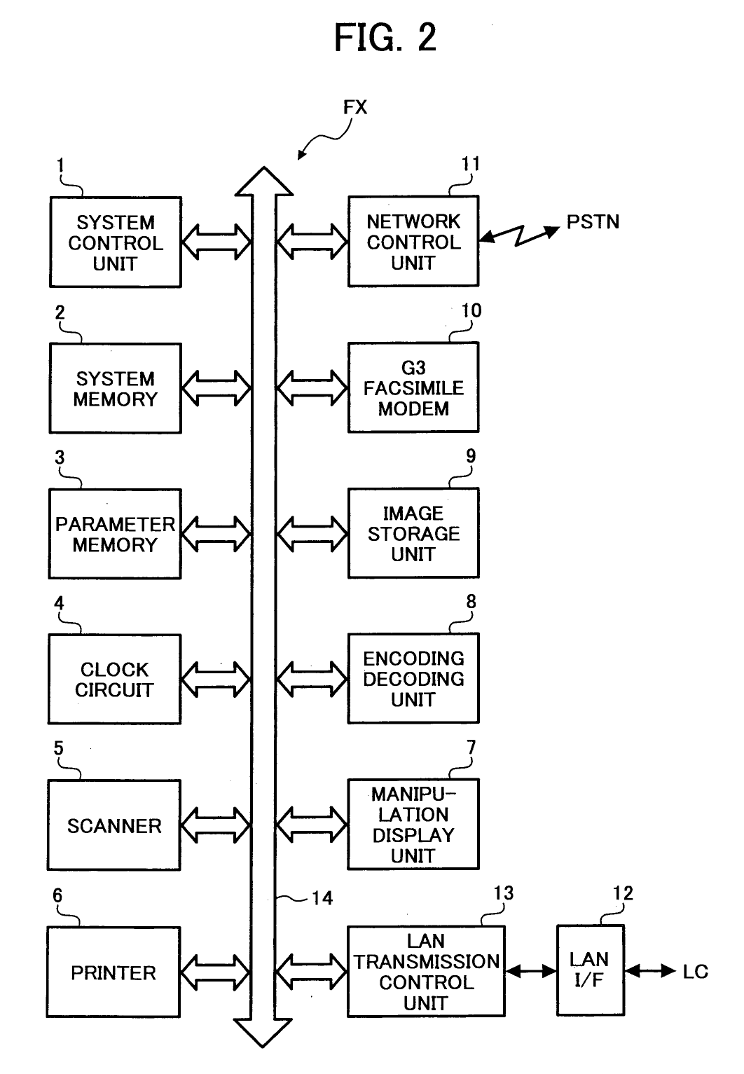

Referring now to FIG. 2, an exemplary structure of the network facsimile FX of the LAN system 100 will be explained.

The network facsimile FX includes a system control unit 1, a system memory 2, a parameter memory 3, a clock circuit 4, a scanner 5, a printer 6, a manipulation display unit 7, an encode/decode unit 8, an image storage unit 9, a G3 facsimile modem 10, a network control unit 11, a LAN interface circuit 12, a LAN transmission control unit 13 and an internal bus 14. The system control unit 1 controls processing of the entire part of the network facsimile FX for a network facsimile operation. The system memory 2 stores a control processing program executed by the system control unit 1 for the network facsimile operation and various data needed to execute a processing program. The system memory 2 also serves as a work area for the system control unit 1 to execute the network facsimile operation. The parameter memory 3 stores unique information associated with the network facsimile FX. The clock circuit 4 outputs present time information and the scanner 5 reads an original image with a predetermined resolution. The printer 6 records and outputs the original image with a predetermined resolution. The manipulation display unit 7 including various manipulation keys and a display unit is used for manipulating the network facsimile FX. The encode/decode unit 8 encodes and compresses data and decodes image information which is encoded and compressed to original image signals. The G3 facsimile modem 10 is provided with a G3 facsimile modem and achieves the G3 facsimile function. The G3 facsimile modem 10 includes a low-speed modem function for negotiation of the transmission procedural signal such as a V. 21 modem, an ITU-T standard for 300 bits per second duplex modems for use on the public switched telephone network (PSTN), for example, and a high-speed modem function for negotiation of image data such as a V. 17, an ITU-T standard for simplex one-way transmission modulation technique for use in extended Group 3 facsimile application, a V. 34 modem, an international standard for dial-up modems of up to 28,800 bits per second, V. 29 modem, an ITU-T standard for a 9,600 bits-per-second modem for use point-to-point used on a line and a V 27ter modem, an ITU-T standard for 2,400/4,800 bits per second modem for use on the switched telephone network, for example. The network control unit 11 includes an automatic call originating/terminating function to connect a call from the network facsimile FX to a destination through an analog public network, that is, PSTN. The LAN interface circuit 12 connects the network facsimile FX to the LAN cable LC and the LAN transmission control unit 13 performs various predetermined protocol suites for a data exchange with other data terminals for achieving the network facsimile operation.

The above-described system control unit 1, the system memory 2, the parameter memory 3, the clock circuit 4, the scanner 5, the printer 6, the manipulation display unit 7, the encode/decode unit 8, the image storage unit 9, the G3 facsimile modem 10, the network control unit 11, the LAN interface circuit 12 and the LAN transmission control unit 13 are connected to each other through the internal bus 14.

Image data between the network control unit 11 and the G3 facsimile modem 10 transact directly.

In one embodiment, a combination of transmission protocols, that is, a protocol suite, TCP/IP which works above a transport layer and the upper layer communication protocol are substantially used in data transaction among terminals connected to the LAN 100.

In another embodiment, a communication protocol, a Simple Mail Transfer Protocol, in other words, SMTP, is applied as a data transaction such as an email data transaction, for example. A Post Office Protocol, that is a POP, is used as a protocol at the time of confirming reception of an email destined for a user or at the time of a request of acquisition. In connection with the communication protocols such as TCP/IP, SMTP, POP, HTTP and FTP, for example, and data format or data structure associated with an email or a transfer file, appropriate protocols are specified in the Request For Comment (RFC) document that progress through several development stages, under the control of an Internet Engineering Task Force (IETF), until they are finalized or discarded.

In the above-described structure, the network facsimile FX receives image information through an email and receives image information from the G3 facsimile through the analog public communications network, that is PSTN.

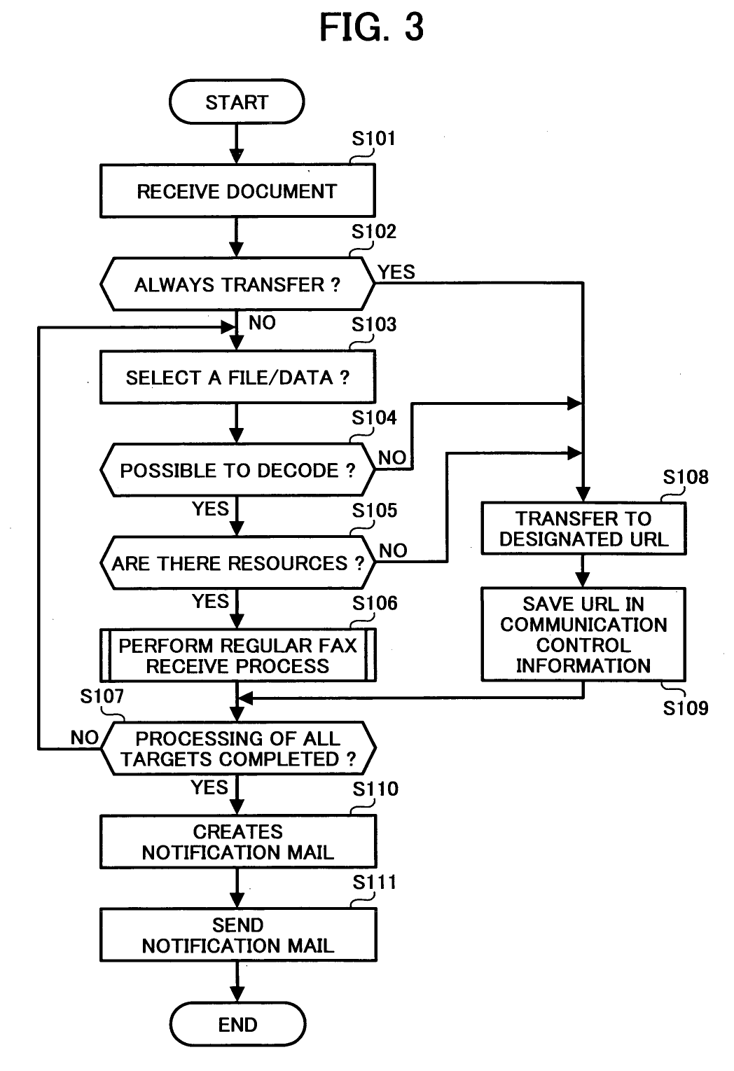

Referring now to FIG. 3, an exemplary procedure of the network facsimile operation performed by the network facsimile FX will be explained.

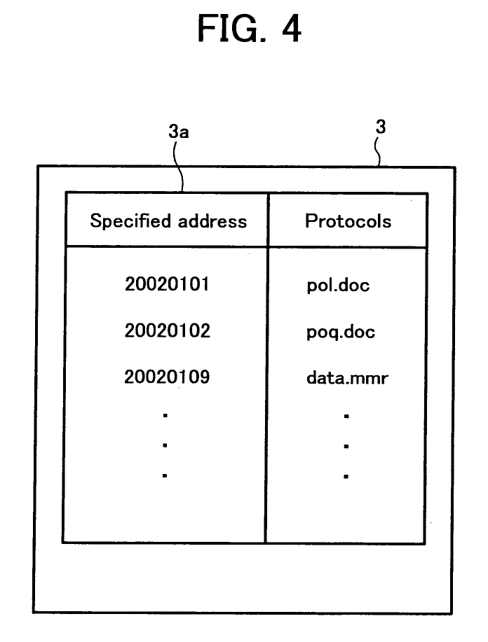

In Step S101, the network facsimile FX receives a document via an email or by fax. In Step S102, the system control unit 1 determines whether the document received is assigned to be forwarded. If the determination result of Step S102 is NO, the system control unit 1 determines that when a document is received by facsimile, the document sent is determined as a file or data in Step S103. Further, in Step S103, when a document is an email, the system control unit 1 determines that when a document is an email, the document is treated as files or data per every MIME part which is actually an extension to SMTP and which covers binary, audio and video data and selects one of the files and data in Step S103. In Step S104, the system control unit 1 determines whether the target file or data can be decoded on the network facsimile FX. If the determination in Step S104 is YES, the system control unit 1 determines whether the network facsimile FX has sufficient resources for storing and outputting the received document in Step S105. If the determination in Step S105 is YES, the system control unit 1 proceeds to a predetermined regular facsimile receiving process performed at the time of document reception in Step S106. After the above-described process, the received document is printed out from the printer 6 or stored in the image storage unit 9. Then, the system control unit 1 examines if all the processes for the target document have been completed in Step S107. If the determination result in Step S107 is NO, the system control unit moves back to Step S103 and repeats the process described so far. When a target file or data to be processed is a PC application and the like and the application file cannot be decoded by the network facsimile FX, the determination result in Step S104 is NO, the determination result in Step S105 is NO and the process also goes to Step S108 and the system control unit 1 forwards the target file or data to a specified URL in Step S108. This occurs, for example, when a tray is low on paper in the printer 6, when there remain a limited amount of toner, or when there remain insufficient resources due to lack of storage space of the image storage unit 9. The system control unit 1 stores the destination URL in communications control information in Step S109, and proceeds to Step S107. FIG. 4 shows a data table 3a of the parameter table 3, including specified addresses assigned to the file server FS to which the target file or data is transferred and protocols which correspond to the specified addresses and by which the target file or data is retrieved and decoded. The destination URL includes one of the specified addresses which are register values, and also one of the protocols of FIG. 4, which are assigned values for acquiring the target file or data that will be forwarded.

If all the processes for the target file or data are completed, and if the determination result in Step S107 is YES and two or more files are forwarded, the system control unit 1 creates a notification mail to notify the destination URL in Step S110 and sends the notification mail that has been created to an address of a predetermined network administrator, for example, in Step S111.

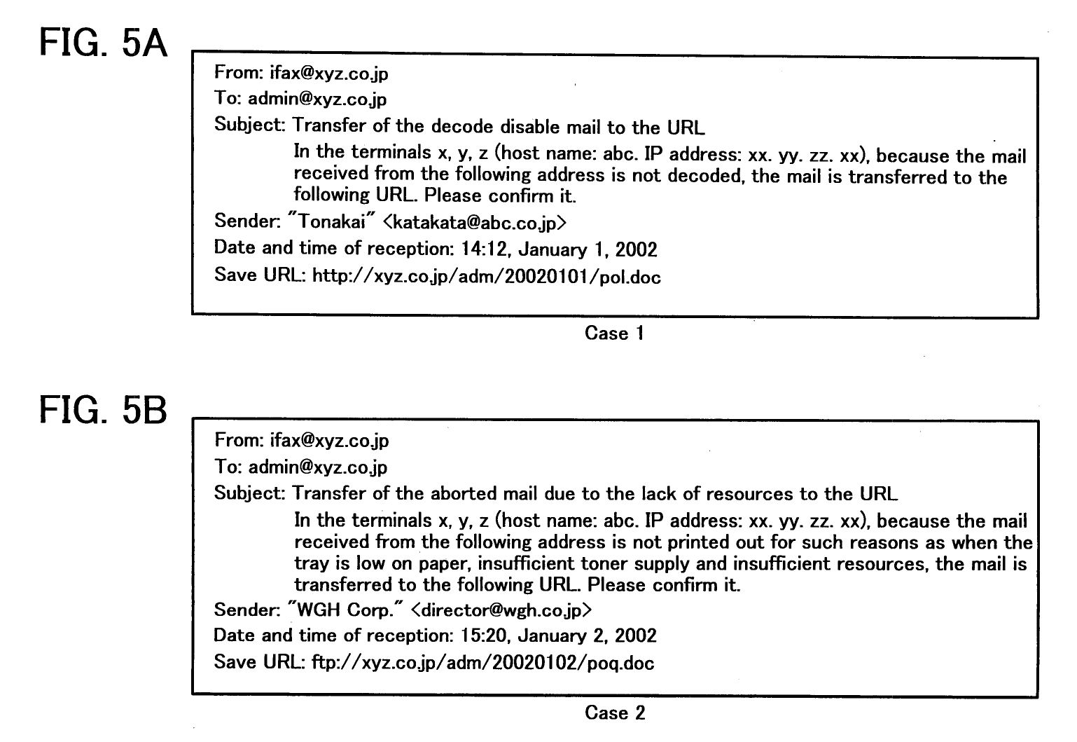

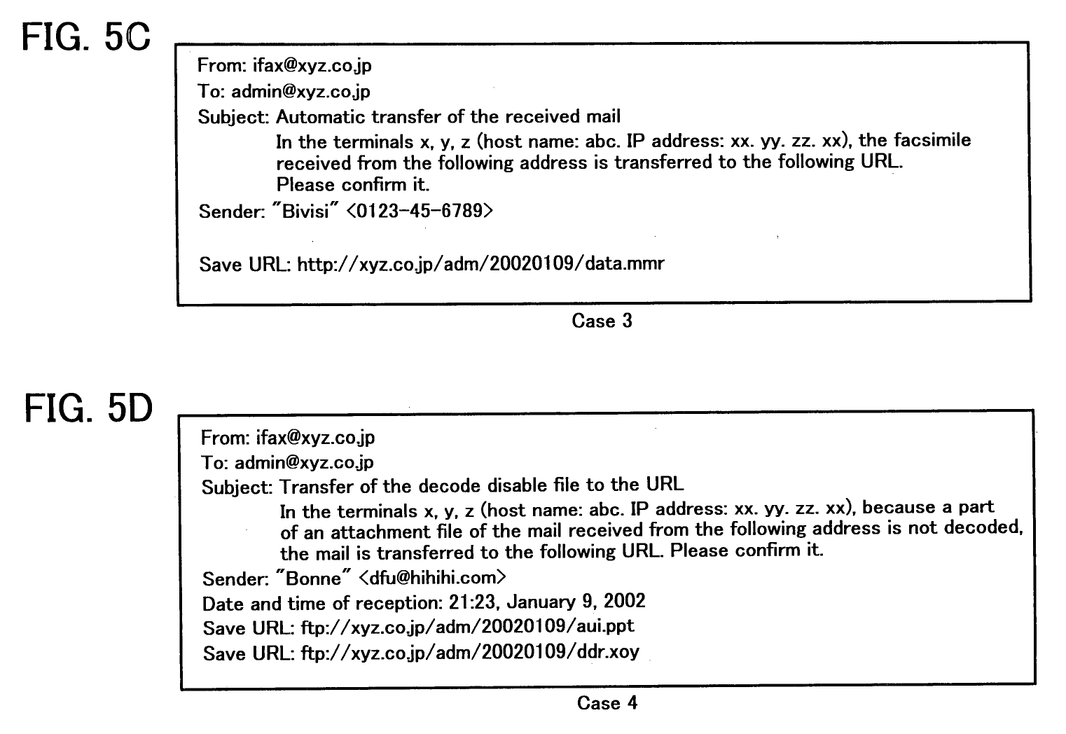

Referring now to FIGS. 4 and 5, exemplary contents of an email created in Step S110 will be shown. Case 1 of FIG. 5A shows an exemplary notification mail notifying that the mail that has been received is forwarded to a specific URL when the mail that has been received cannot be decoded or when all the MIME parts cannot be decoded. Case 2 of FIG. 5B shows an exemplary notification mail notifying that the mail that has been received is forwarded to a specific URL due to insufficient resources such as when the tray is low on paper, or there remain insufficient toner, for example. Case 3 of FIG. 5C shows an exemplary notification mail notifying that the mail that has been received is forwarded to a specific URL regardless of mail reception and facsimile reception.

Referring to Case 4 of FIG. 5D, an exemplary notification mail notifying that when a part of the received mail (i.e., one of the MIME parts) is not decoded, the part of the received mail is transferred to a specific URL.

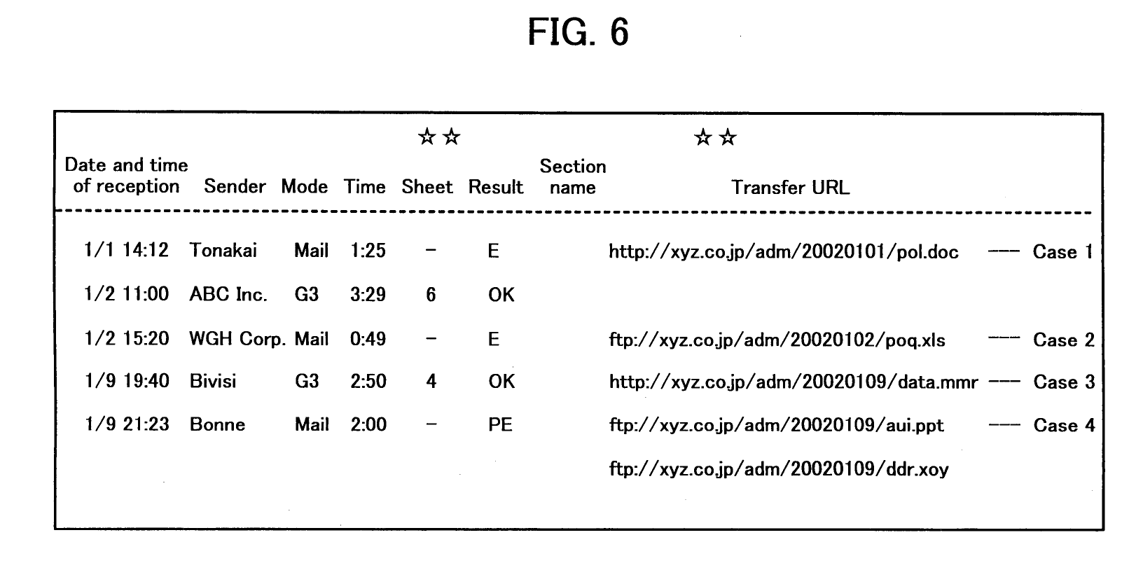

Referring now to FIG. 6, an exemplary communications control report indicating Cases 1 through 4 will be explained. Cases 1 through 4 of FIG. 6 correspond to contents associated with the respective events occurring in the notification mail shown in the above-described Cases 1, 2, 3 and 4. A destination URL is input to the manipulation display unit 7 or a destination URL is automatically assigned. Email address of the network administrator is input with the use of the manipulation display unit 7.

In the embodiment described above, when a document that has been received is not properly handled, the system control unit 1 notifies the network administrator via an email that the document that has been received was not properly handled, and although occurrence of the case is stored in the communications control report, it is possible to do simultaneously at least one of notifying the facts to the network administrator and recording into the communication control report.

When the network facsimile FX is set in a mode where a document that has been received is assigned to be forwarded, the amount of resources used by the network facsimile FX can be decreased. When the document that has been received is not decoded by the network facsimile FX, the document can be stored in an external file server. Hence, a document that has been received would not be misplaced or deleted.

Abnormal events such as loss of the document that has been received can be avoided because when a document that has been received is not output to the printer 6, the document can be stored in external equipment. Bug information associated with the network facsimile FX and information on where a document that has been received is stored can be appropriately provided to the network administrator by notifying a destination URL to an address of the network administrator by email. It is also convenient that by writing the destination URL in the communications report, forward history or storage location of a document can be recorded, thereby correlating the destination to be sent with the destination to be forwarded, that is, the network administrator can obtain the document that has been received from the destination to be forwarded, for example.

Additionally, there are various kinds of determination standard to determine whether a document is forwarded. It is determined whether a document is forwarded based on the sender of the document such as a From address or an IP address. The standards for determining whether a document is forwarded can include the number of pages sent, size of email, content-type and encryption.

The patent specification can be applicable to network communication apparatuses other than the network facsimile such as a copying machine with network communications function.

Numerous additional modifications and variations are possible in light of the above teachings. It is therefore to be understood that within the scope of the appended claims, the disclosure of this patent specification may be practiced otherwise than as specifically described herein.

This patent specification is based on and claims priority to Japanese patent application, No. JPAP2002-256418 filed on Sep. 2, 2002, in the Japanese Patent Office, the entire contents of which are incorporated by reference herein.

What is claimed is:

1. A network terminal apparatus connected to a local area network and a public switched telephone network, comprising:
an information receiving mechanism configured to receive one of facsimile information and email;
a memory storing a plurality of addresses assigned in a file server connected to the local area network and a plurality of protocols corresponding to the plurality of addresses;
an information transmitting mechanism configured to transmit said one of facsimile information and email received by the information receiving mechanism to a universal resource locator including information of one of the plurality of addresses and corresponding one of the plurality of protocols when a specific event occurs; and
an email generator configured to generate an email indicating the universal resource locator to a specific email address.

2. The network terminal apparatus as defined in claim 1, wherein the specific event is that a part or an entire portion of said one of facsimile information and email received is not decodable.

3. The network terminal apparatus as defined in claim 1, wherein the specific event is that a document of said one of facsimile information and email received is not printed out or saved.

4. The network terminal apparatus as defined in claim 1, wherein the specific event is that a part or an entire portion of said one of facsimile information and email received is not printed out or saved.

5. The network terminal as defined in claim 1, wherein a forward URL is included in contents of a predetermined communication control report which stores a communication history.

6. A network terminal apparatus connected to a local area network and a public switched telephone network, comprising:
an information receiving means to receive one of facsimile information and email;
a memory storing a plurality of addresses assigned in a file server connected to the local area network and a plurality of protocols corresponding to the plurality of addresses;
an information transmitting means to transmit said one of facsimile information and email received by the information receiving mechanism to a universal resource locator including information of one of the plurality of addresses and corresponding one of the plurality of protocols when a specific event occurs; and
an email generating means to generate an email indicating the universal resource locator to a specific email address.

7. The network terminal apparatus as defined in claim 6, wherein the specific event is that a part or an entire portion of said one of facsimile information and email received is not decodable.

8. The network terminal apparatus as defined in claim 6, wherein the specific event is that a document of said one of facsimile information and email received is not printed out or saved.

9. The network terminal apparatus as defined in claim 6, wherein the specific event is that a part or an entire portion of said one of facsimile information and email received is not printed out or saved.

10. The network terminal as defined in claim 6, wherein a forward URL is included in contents of a predetermined communication control report which stores a communication history.

11. A method carried out by a network terminal apparatus connected to a local area network and a public switched telephone network, comprising the steps of:
receiving one of facsimile information and email;
storing a plurality of addresses assigned in a file server connected to the local area network and a plurality of protocols corresponding to the plurality of addresses;
transmitting said one of facsimile information and email received by the information receiving mechanism to a universal resource locator including information of one of the plurality of addresses and corresponding one of the plurality of protocols when a specific event occurs; and
generating an email indicating the universal resource locator to a specific email address.

12. The method as defined in claim 11, wherein the specific event is that a part or an entire portion of said one of facsimile information and email received is not decodable.

13. The method as defined in claim 11, wherein the specific event is that a document of said one of facsimile information and email received is not printed out or saved.

14. The method as defined in claim 11, wherein the specific event is that a part or an entire portion of said one of facsimile information and email received is not printed out or saved.

15. The method as defined in claim 11, wherein a forward URL is included in contents of a predetermined communication control report which stores a communication history.

16. A method of operating a network terminal apparatus connected to a local area network and to a public switched telephone network, comprising:
storing in said network terminal apparatus a plurality protocols associated with respective specified events;
receiving at the network terminal apparatus an information stream that includes both facsimile transmissions and email transmissions;
detecting whether each facsimile and email transmission received at the network terminal apparatus is associated with a respective one of said specified events and, in response to a determination of an association, transferring to a selected universal resource locator (URL) selected information regarding the facsimile or email transmission determined to be associated with the specified event and regarding the protocol associated with the specified event; and
generating an email addressed to an email address associated with the facsimile or email transmission determined to be associated with the specified event, said generated email including information identifying said URL; and
sending the generated email to the email address associated with the facsimile or email determined to be associated with the specified event.

17. A method as in claim 16 in which the specified events comprise one or more of a failure to decode a facsimile or email transmission received at the network terminal apparatus, failure to print the transmission, and failure to save the transmission.

18. A network terminal apparatus connected to a local area network and to a public switched telephone network, comprising:
memory facilities storing in said network terminal apparatus a plurality protocols associated with respective specified events;
receiving facilities at the network terminal apparatus configured to receive an information stream that includes both facsimile transmissions and email transmissions;
detecting facilities at said network terminal apparatus configured to detect whether each facsimile and email transmission received at the network terminal apparatus is associated with a respective one of said specified events;
transferring facilities responsive to a determination of an association, configured to transfer to a selected universal resource locator (URL) selected information regarding the facsimile or email transmission determined to be associated with the specified event and regarding the protocol associated with the specified event; and
an email generator configured to generate an email addressed to an email address associated with the facsimile or email transmission determined to be associated with the specified event, said generated email including information identifying said URL; and
an email sender configured to send the generated email to the email address associated with the facsimile or email determined to be associated with the specified event.

19. A network terminal apparatus as in claim 18 in which the specified events comprise one or more of a failure to decode a facsimile or email transmission received at the network terminal apparatus, failure to print the transmission, and failure to save the transmission.
